(19) United States
(12) Patent Application Publication
(10) Pub. No.: US 2026/0052336 A1
(43) Pub. Date: Feb. 19, 2026

(54) A CONSTANT BEAMWIDTH LOUDSPEAKER

(71) Applicant: PASCAL A/S, Herlev (DK)

(72) Inventors: Hugh Sarvis, Greensboro, NC (US); D. Broadus Keele, Jr., Bloomington, IN (US); Lars Rosenkvist Fenger, Frederiksberg (DK)

(73) Assignee: PASCAL A/S, Herlev (DK)

(21) Appl. No.: 19/102,166

(22) PCT Filed: Jul. 3, 2023
(86) PCT No.: PCT/EP2023/068226

§ 371 Date: Feb. 7, 2025

Related U.S. Application Data
(60) Provisional application No. 63/370,975, filed on Aug. 10, 2022.

(30) Foreign Application Priority Data
Sep. 13, 2022 (EP) 22195351.6

(51) Int. Cl. H04R 1/22; H04R 1/40

(52) U.S. Cl. CPC H04R 1/227; H04R 1/403; H04R 2201/401; H04R 2430/01

(57) ABSTRACT

A constant beamwidth loudspeaker A constant beamwidth loudspeaker having a plurality of transducer units/drivers. The transducers are combined in series and parallel for approximating a constant beam-width/directivity without attenuating any of the transducers with resistor components. The transducers are arranged on a circular arc.

The present disclosure relates to a transducer system for outputting sound (acoustical signal) in a radiation pattern having a substantially constant directivity across a frequency range.

In the field such a loudspeaker is normally termed a constant beamwidth loudspeaker. It is intended to be used for large venues such as concert halls, theatres, auditoriums, stadiums, arenas, house of worship, bars, clubs, etc. Such venues often have problems with the sound field being distorted, because the radiation pattern of a sound fields generated by a typical loudspeaker vary with frequency. Such a sound field also may not be focused and spectral content of the sound field may vary with direction. In applications where a sound filed is generated in an enclosed or a partially enclosed space an unfocused sound field may cause constructive and destructive wave interference patterns which may further distort the sound field at different locations.

A theoretically ideal loudspeaker on the other hand produces a sound field with a spectral content that does not vary with direction, and has a radiation pattern that is constant over a wide frequency range. For certain applications, such as use in an enclosed or partially enclosed space it may be desirable to have a loudspeaker that has constant directivity in addition to a radiation pattern that

is constant over a wide frequency range. A loudspeaker with a radiation pattern that does not differ significantly with respect to frequency is referred to as a constant-directivity or a constant-beamwidth loudspeaker.

An example of a constant beamwidth loudspeaker is disclosed in U.S. Pat. No. 7,826,622 which is incorporated in the present disclosure by reference.

U.S. Pat. No. 7,826,622 discloses a loudspeaker for receiving an incoming electrical signal and transmitting an acoustical signal that is directional and has a substantially constant beamwidth over a frequency. The loudspeaker may include a curved mounting plate outer surface for mounting a plurality of speaker drivers/array. The loudspeaker may include an array of speaker drivers/transducer units coupled to the mounting plate. Each speaker driver may be powered by a respective electrical signal having an attenuation level that is a function of the speaker driver's location on the mounting plate with the array of speaker drivers. The function is typically called a shading function, because the (amplitude) level at which a speaker unit outputs sound is attenuated from one speaker unit to the next. The shading function may be based on a Legendre function. Providing a varying amplitude level along the array may be achieved with a multi-channel amplifier or with a resistor network (placing resistor components in the circuit with the speaker drivers). However, a multi-channel amplifier may have a high cost and resistor components reduces the efficiency.

A desirable radiation pattern has a beam in front of the speaker with a constant beam width over a frequency range. That is the audience is to hear the same (non-distorted) sound whether standing in the middle, to the left or to the right.

A first aspect of the present disclosure is:

A transducer system for outputting sound in a radiation pattern having a substantially constant directivity/beamwidth across a frequency range, said transducer system comprising:
an input,
a plurality of transducer units, each transducer unit connected to said input for receiving an electric signal and converting said electric signal to sound,
said plurality of transducer units arranged on a curve, said curve having a finite radius,
said plurality of transducer units comprising at least a first transducer unit, a second transducer unit, and a third transducer unit.

The input may constitute a terminal for inputting an electric signal.

A transducer unit constitute a speaker driver which converts the electric input signal to sound (acoustic signal).

The beamwidth is preferably in the horizontal plane.

A substantially constant beam width is to be understood as a beam width that in a frequency range (for example from 2.5 kHz to 20 kHz) does not deviate with more than 25%, i.e. the difference between the maximum beam width and the minimum beam width in the frequency range is not more than 25% compared to the maximum beam width.

Each transducer unit of the plurality of transducer units may be connected to the input substantially unattenuated—not withstanding line resistance or splitters, i.e. each transducer unit of the plurality of transducer units may be connected to the input without resistor networks—without resistor components in series with any of the transducer units. In this setting a transducer is not to be considered a resistor component.

The plurality of transducer units may be driven exclusively at two amplitude (shading) levels or gain shading levels including a first amplitude (shading) level and a second amplitude (shading) level during intended operational use of said transducer system, i.e. the transducer units may be arranged in an electric circuit such that the electric circuit only has two amplitude (shading) levels. The first amplitude level may be substantially twice (+/−20%) that of the second amplitude level, it may not exactly be twice as high due to line resistance for example. The shading may be symmetric with respect to the center of the array and the shading decreases going outwards, i.e. a system comprising three banks has the same shading level for the transducers in the middle/center bank and the transducers in the two banks on opposite sides has a lower shading level such as substantially 50% lower than the center bank.

An amplitude shading level is to be understood as a factor that may be multiplied onto the input signal applied at the input of the transducer system.

In the following specific examples according to aspects of the present disclosure will be explained in more detail with reference to the accompanying drawings. The present disclosure may, however, be embodied in different forms than depicted below, and should not be construed as limited to any examples set forth herein. Rather, any examples are provided so that the disclosure will be thorough and complete, and will fully convey the scope of the invention to those skilled in the art. Like reference numerals refer to like elements throughout. Like elements will, thus, not be described in detail with respect to the description of each figure.

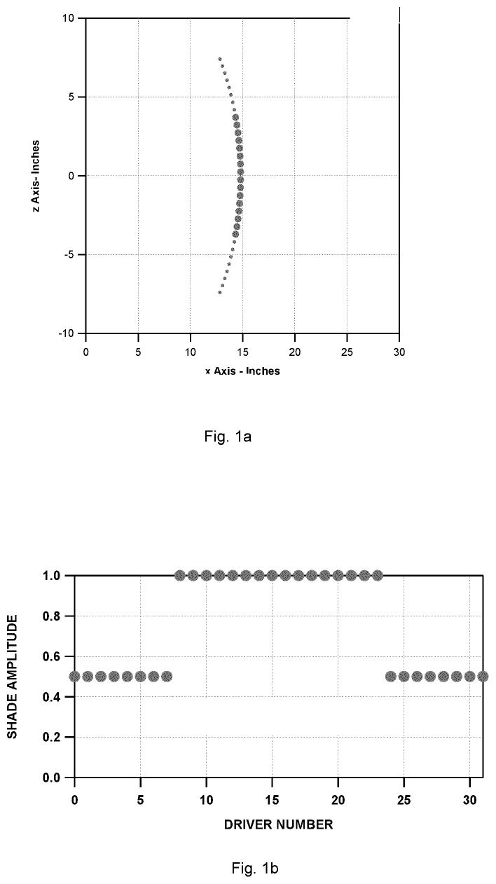

FIG. 1a illustrates a graph of amplitude levels for a transducer system. Each dot in the graph shows the physical location of a respective transduce unit in the xz-plane and the size (bold emphasis/fat or non-bold emphasis/thin) of a dot represents the amplitude (shading) level of a respective transducer unit. The amplitude shading may be considered a factor which is multiplied onto the input signal.

The transducer system may constitute a loudspeaker with the transducer units enclosed in a cabinet.

The transducer system has 32 transducer units/speaker drivers. This is typically called a (vertical) line array. The transducer (units) are divided into three banks:
a first bank which is constituted by the 16 transducers in the middle (center bank), which is illustrated by the bold dots,
a second bank which is constituted by the 8 transducers below the center bank (bottom bank), which is illustrated by the lowest 8 non-bold dots,
a third bank which is constituted by the 8 transducers above the center bank (top bank), which is illustrated by the highest 8 non-bold dots.

There may be less or more transducer units in total and in the different bank. Examples of different number of transducers in the transducer system follows below.

The transducer units are physically arranged on a circular arc, i.e. a curve having a constant radius (and that is finite/less than infinite—a curve with an infinite radius is a straight line). The circular arc is arranged in a vertical plane.

Other non-straight curves may be contemplated, for example a segment of an ellipse or a curve with a varying radius.

As can be seen on the graph of FIG. 1, the transducer system has a height of about 15 inches—the vertical distance between the upper most transducer unit and the lower most transducer unit.

The amplitude level/shading of a respective transducer unit depends on the position on the curve, which is illustrated by the size of the dot for each transducer unit. The transducers of the center bank have an amplitude shading of 1, and the 16 transducers of the bottom and top banks have an amplitude shading of 0.5, that is the transducers of the center bank are driven at an amplitude level which is twice that of the transducers of the bottom bank or top bank—this may also be referred to as 50%-50% 6 dB shading (or 50-50 shading), because it is shading exclusively at two shading levels.

FIG. 1b illustrates a graph showing the amplitude (shading) level as a function of transducer number. The first 8 transducers (0-7) are the transducers of the bottom bank, which have an amplitude shading of 0.5. The next 16 transducers (8-23) are the transducers of the center bank, which have an amplitude shading of 1, and the next 8 transducers (24-31) are the transducers of the top bank, which have an amplitude shading of 0.5.

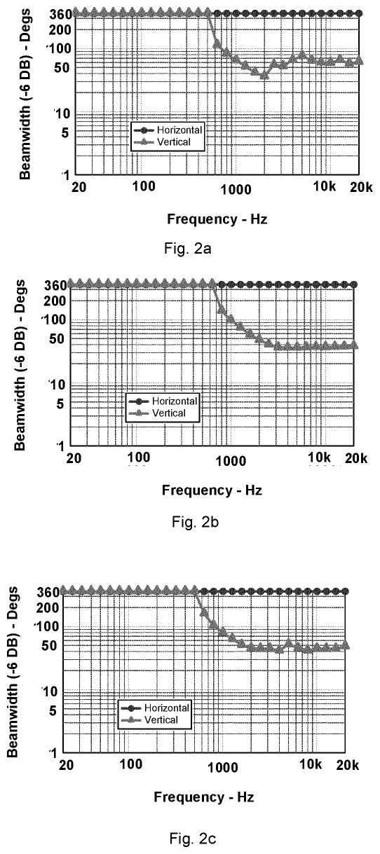

FIG. 2a shows the beam width at 6 dB as a function of frequency of the sound field produced by the 32 transducers physically arranged as illustrated in FIG. 1a, but with no shading applied, i.e. all the speakers are driven at the same amplitude level.

The graph with the dots is in the vertical plane while the graph with the triangles is in the horizontal plane, which is the graph describing the effect of the shading (FIGS. 2b and 2c) while FIG. 2a shows the beam width for no shading.

Speech is in the range about 1 kHz to 3 kHz and the human ear may have a hearing range that goes up to a frequency of 20 KHz.

As can be seen in FIG. 2a, the radiation pattern is omnidirectional up to about 500 Hz and after that it falls down.

FIG. 2b shows the beam width at 6 dB as a function of frequency of the sound field produced by the 32 transducers physically arranged as illustrated in FIG. 1a, and with a shading according to a Legendre function. The (value of) shading level of each of the transducers is shown in the table below for both the Legendre shading, no shading and 50-50 shading.

Value of shading level

| Transducer | No shading | Legendre | 50-50 |
|---|---|---|---|
| 0 | 1 | 0 | 0 |
| 1 | 1 | 0.087 | 0 |
| 2 | 1 | 0.177 | 0 |
| 3 | 1 | 0.268 | 0 |
| 4 | 1 | 0.358 | 0 |
| 5 | 1 | 0.447 | 0 |
| 6 | 1 | 0.533 | 0 |
| 7 | 1 | 0.616 | 0 |
| 8 | 1 | 0.694 | 1 |
| 9 | 1 | 0.765 | 1 |
| 10 | 1 | 0.830 | 1 |
| 11 | 1 | 0.885 | 1 |
| 12 | 1 | 0.932 | 1 |
| 13 | 1 | 0.967 | 1 |
| 14 | 1 | 0.990 | 1 |
| 15 | 1 | 1 | 1 |
| 16 | 1 | 1 | 1 |
| 17 | 1 | 0.990 | 1 |
| 18 | 1 | 0.967 | 1 |
| 19 | 1 | 0.932 | 1 |
| 20 | 1 | 0.885 | 1 |
| 21 | 1 | 0.830 | 1 |
| 22 | 1 | 0.765 | 1 |
| 23 | 1 | 0.694 | 1 |
| 24 | 1 | 0.616 | 0 |
| 25 | 1 | 0.533 | 0 |
| 26 | 1 | 0.447 | 0 |
| 27 | 1 | 0.358 | 0 |
| 28 | 1 | 0.268 | 0 |
| 29 | 1 | 0.177 | 0 |
| 30 | 1 | 0.087 | 0 |
| 31 | 1 | 0 | 0 |

As can be seen in FIG. 2b the beam width is between 20 and 30 degrees from above about 2.5 kHz (the graph with the triangles).

FIG. 2c shows the beam width at 6 dB as a function of frequency of the sound field produced by the 32 transducers physically arranged as illustrated in FIG. 1a, and with a 50-50 shading, i.e. the shading with the amplitude shading levels/values illustrated in FIG. 1b.

As can be seen in FIG. 2c the beam width is between 40 and 50 degrees from just below 2 kHz (the graph with the triangles), i.e. it varies between 40 and 50 degrees from above 2 kHz with 40 degrees as the minimum and 50 degrees as the maximum. This may be termed the “constant” beam width range.

Thus, compared to the effect of the Legendre shading illustrated in FIG. 2b, the beam width is down in the “constant” beam width range (40-50 degrees) at a lower frequency (just below 2 kHz). And the constant beam width range is greater, i.e. the range 40-50 degrees compared to the range 20-30 degrees for the Legrende shading.

Although, the “50-50” shading does show a bit more variation, i.e. the difference between the lowest beam width and the highest beam width (above 2.5 kHz) is greater for the 50-50 shading of FIG. 2c than for the Legendre shading of FIG. 2b.

Overall, the “50-50” shading results in an good pattern control with only two amplitude shading levels.

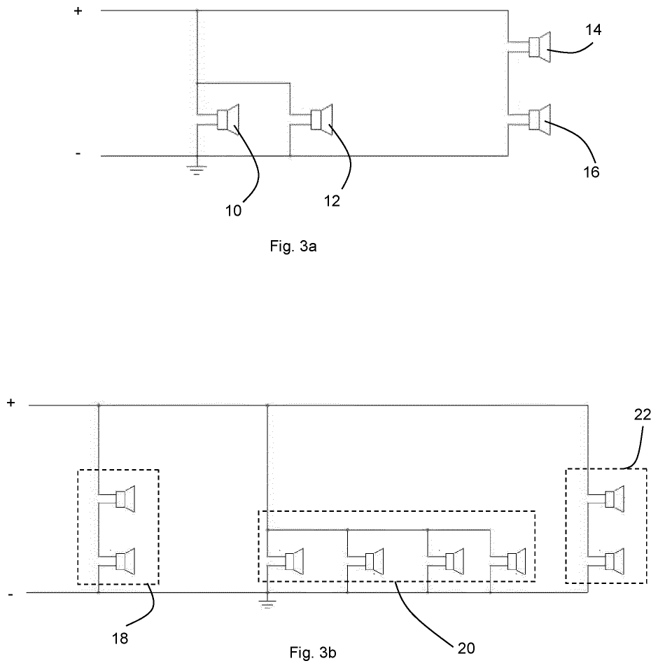

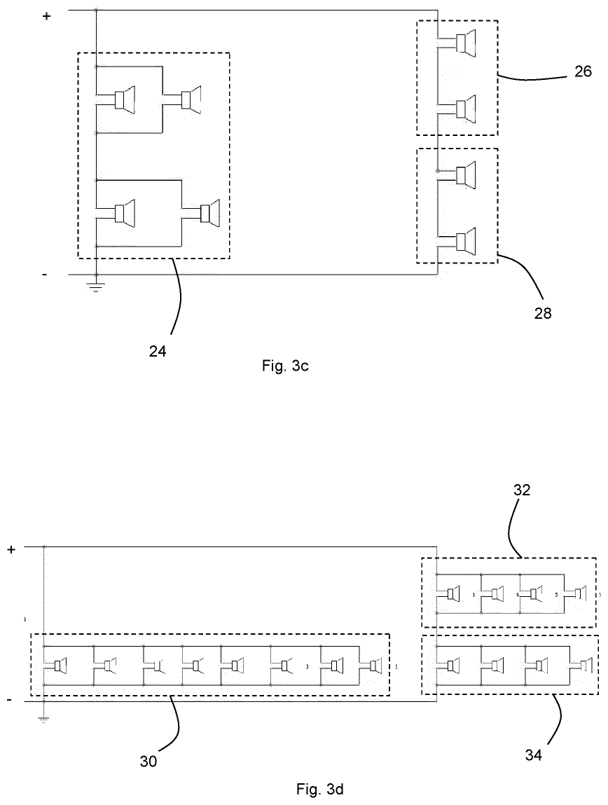

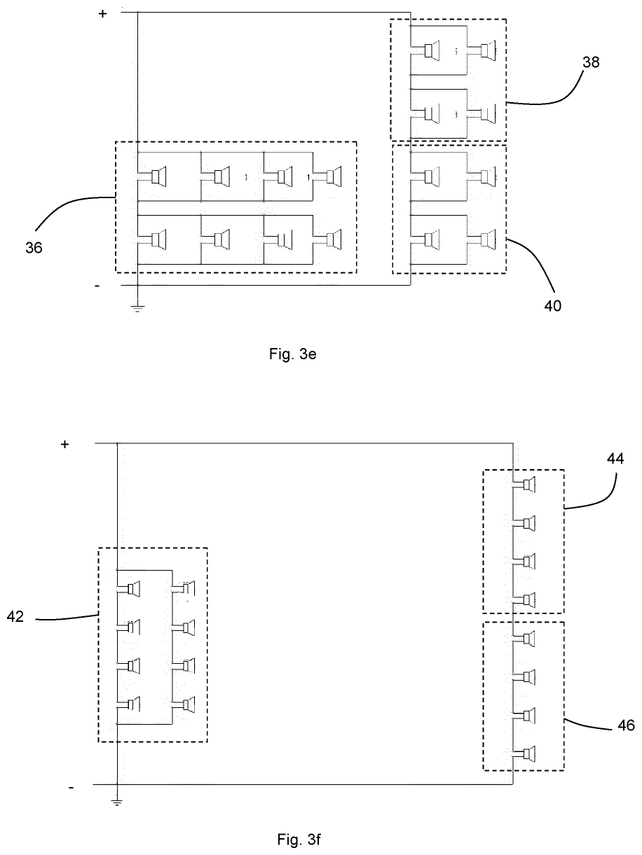

FIG. 3a shows a schematic of an electric circuit for an example of a transducer system/loudspeaker.

The transducer system comprises four transducer units, which are divided into three banks. The first bank comprises two transducer units including a first transducer unit 10 and a second transducer unit 12. The second bank comprises a third transducer unit 14, and the third bank comprises a fourth transducer unit 16.

The second and third transducer banks are connected in series to the input (illustrated with the plus and minus sign).

The two transducer units of the first bank are connected in parallel to the input.

The first transducer bank is connected in parallel to the second and third transducer banks.

In general, the constant beam width may be achieved or approximated with a first transducer bank in parallel with a second transducer bank, wherein the second transducer bank has more transducers than the first transducer bank and the transducers of the second transducer bank are placed on opposite sides of the first transducer bank—and the transducers of the second bank connected in series.

And with all the transducers on a curve—the curve being convex when observing the curve from a position in front of the loudspeaker, i.e. it has a single minimum—the ends of the curve being further from the audience than the center of the loudspeaker (corresponding to the audience being at the x-axis of a coordinate system and the curve being above the x-axis).

It is contemplated that all of the transducers has substantially the same impedance, i.e. the difference in impedance from one transducer to another does not differ more than 20% such as not more than 10% or 5%.

Assuming the impedance of each transducer is 8 Ohm the impedance of the first transducer bank is

$$\frac{1}{{Z}_{1}} = \frac{1}{8} + \frac{1}{8} = \frac{1}{4}$$

And the impedance of the circuit is

$$\frac{1}{Z} = \frac{1}{{Z}_{1}} + \frac{1}{{Z}_{2} + {Z}_{3}} = \frac{1}{4} + \frac{1}{8 + 8} = \frac{5}{16}$$

Resulting in Z=16/5=3.2 Ohm.

The two transducers of the first bank has a full voltage drop and therefore has no shading of the amplitude level, i.e. they play at full amplitude level, shaded at 0 dB.

The two other transducer (the one of the second bank and the one of the third bank) are in series and each has half a voltage drop resulting in that they play at half the level compared to the first bank, i.e. they have a amplitude shading level of 0.5, shaded at −6 dB.

The circuits in the following figures can be said to be expansions of the circuit on FIG. 3a, i.e. they constitute circuits for loudspeakers with a higher number of transducer units than in FIG. 3a and with varying impedance.

FIG. 3b shows a schematic of an electric circuit for another example of a transducer system.

The transducer system comprises 8 transducer units, which are divided into three banks. The first bank 18 comprises two transducer units. The second bank 20 comprises four transducer units, and the third bank 22 comprises two transducer units.

The transducers of the second bank are all connected in parallel to the input and therefore has a shading of 0 dB. The transducers of the first bank and the second bank are connected in series and therefore has a shading of −6 dB. The first and third banks are on opposite sides of the second bank on the array curve.

Assuming 8 Ohm transducers, the circuit has an impedance of 1.6 Ohm.

In FIG. 3c the circuit has 8 transducers, which are divided into three banks. The first bank 24 comprises two transducer units.

The second bank 26 comprises four transducer units, and the third bank 28 comprises two transducer units. It is an example of a loudspeaker with four center units and two units on each side like in FIG. 3b, but with a different impedance. For this circuit the impedance is 6.4 Ohms. The transducers of banks two and three are placed on opposite sides of the first bank. The four transducers of the second and third banks are connected in series and each has a voltage drop of ¼. The first bank has two parallel transducers in series with another two parallel transducers.

FIG. 3d shows an example of a low impedance loudspeaker (0.8 Ohms when each transducer is 8 Ohms).

The center bank 30 has 8 transducers and the upper bank 32 has 4 transducers and the lower bank 34 also has 4 transducers. The transducers in each bank are in parallel with each other. The circuit is similar to the circuit of FIG. 3a in that the number of transducers in each bank has been multiplied with a factor 2.

In FIG. 3e the center bank 36 also has 8 transducers while the upper bank 38 has 4 transducers and the lower bank 40 has 4 transducers. Assuming 8 Ohm transducers, the impedance of the circuit is 3.2 Ohm.

FIG. 3f shows an example of a high impedance loudspeaker (12.8 Ohms when each transducer is 8 Ohms).

The center bank 42 has 8 transducers while the upper bank 44 has 4 transducers and the lower bank 46 has 4 transducers.

The 8 transducers of the center bank is arranged as two series of 4 transducers in parallel with each other while the 8 transducers of the upper and lower banks are in series.

Now follows a set of points, which constitute aspects of the present disclosure which may be considered independently patentable and as such the following sets form basis for possible future sets of claims:
1. A transducer system for outputting sound in a radiation pattern having a substantially constant directivity across a frequency range, said transducer system comprising:
   an input,
   a plurality of transducer units, each transducer unit connected to said input for receiving an electric signal and converting said electric signal to sound,
   said plurality of transducer units arranged on a curve, said curve having a finite radius,
   said plurality of transducer units comprising at least a first transducer unit, a second transducer unit, and a third transducer unit.
2. The transducer system according to any of the preceding items, each transducer unit of said plurality of transducer units connected to said input substantially unattenuated.
3. The transducer system according to any of the preceding items, each transducer unit of said plurality of transducer unit connected to said input without resistor networks.
4. The transducer system according to any of the preceding items, said plurality of transducer units driven exclusively at two amplitude levels or gain shading levels including a first amplitude level and a second amplitude level during intended operational use of said transducer system.
5. The transducer system according to any of the preceding items, said plurality of transducer units driven at more than one amplitude level and no more than two amplitude levels during intended operational use of said transducer system.
6. The transducer system according to any of the preceding items, said first amplitude level being substantially two times greater than said second amplitude level.
7. The transducer system according to any of the preceding items, said second transducer unit driven at said first amplitude level during intended operational use of said transducer system.
8. The transducer system according to any of the preceding items, said first transducer unit and said third driven at said second amplitude level during intended operational use of said transducer system.
9. The transducer system according to any of the preceding items, said second amplitude level being equal to 50% plus or minus 10% of said first amplitude level.
10. The transducer system according to any of the preceding items, said plurality of transducer units arranged in a single cabinet.
11. The transducer system according to any of the preceding items, said first transducer unit having a first impedance, said second transducer unit having a second impedance, and said third transducer unit having a third impedance, said first impedance preferably being different from said second impedance.
12. The transducer system according to any of the preceding items, said first impedance being equal to said third impedance plus or minus 15%.
13. The transducer system according to any of the preceding items, said second impedance being equal to 50% plus or minus 10% of said first impedance.
14. The transducer system according to any of the preceding items, at least one of the transducer units of said plurality of transducers units facing in a direction substantially opposite than the rest.
15. The transducer system according to any of the preceding items, said first transducer unit being part of a first transducer bank.
16. The transducer system according to any of the preceding items, said second transducer unit being part of a second transducer bank.
17. The transducer system according to any of the preceding items, said third transducer unit being part of a third transducer bank.
18. The transducer system according to any of the preceding items, said first transducer unit and said third transducer unit connected in series to said input.
19. The transducer system according to any of the preceding items, said second transducer unit connected substantially unattenuated in parallel with said first transducer unit and said third transducer unit to said input,
20. The transducer system according to any of the preceding items, said plurality of transducers driven at substantially the same phase during intended operational use of said transducer system.
21. The transducer system according to any of the preceding items, said first transducer unit, and said third transducer unit arranged on opposite sides of said second transducer unit or on the same side of said second transducer unit.

1. A transducer system for outputting sound in a radiation pattern having a substantially constant directivity across a frequency range, the transducer system comprising:
an input; and
a plurality of transducer units, each transducer unit connected to the input for receiving an electric signal and converting the electric signal to sound,
the plurality of transducer units arranged on a curve, the curve having a finite radius,
the plurality of transducer units comprising at least a first transducer unit, a second transducer unit, and a third transducer unit, and
each transducer unit of the plurality of transducer units connected to the input substantially unattenuated.

2. The transducer system according to claim 1, wherein each transducer unit of the plurality of transducer units is connected to the input without resistor networks.

3. The transducer system according to claim 1, wherein the plurality of transducer units driven exclusively at two amplitude levels or gain shading levels includes a first amplitude level and a second amplitude level during intended operational use of the transducer system.

4. The transducer system according to claim 1, wherein the plurality of transducer units are driven at more than one amplitude level and no more than two amplitude levels during intended operational use of the transducer system.

5. The transducer system according to claim 3, wherein the first amplitude level is substantially two times greater than the second amplitude level.

6. The transducer system according to claim 3, wherein the second transducer unit is driven at the first amplitude level during an intended operational use of the transducer system.

7. The transducer system according to claim 3, wherein the first transducer unit and the third transducer unit are driven at the second amplitude level during an intended operational use of the transducer system.

8. The transducer system according to claim 3, wherein the second amplitude level is equal to 50% plus or minus 10% of the first amplitude level.

9. The transducer system according to claim 1, wherein the first transducer unit has a first impedance, the second transducer unit has a second impedance, and the third transducer unit having has a third impedance, the first impedance is different from the second impedance.

10. The transducer system according to claim 9, wherein the first impedance is equal to the third impedance plus or minus 15%.

11. The transducer system according to claim 9, wherein the second impedance being equal to 50% plus or minus 10% of the first impedance.

12. The transducer system according to claim 1, wherein at least one of the transducer units of the plurality of transducer units is facing in a direction substantially opposite than a remainder of the plurality of transducer units.

13. The transducer system according to claim 1, wherein the first transducer unit and the third transducer unit are connected in series to the input.

14. The transducer system according to claim 1, wherein the second transducer unit is connected substantially unattenuated in parallel with the first transducer unit and the third transducer unit is coupled to the input.

15. The transducer system according to claim 1, wherein the plurality of transducer units are driven at substantially the same phase during intended operational use of the transducer system.
